(19) United States
(12) Patent Application Publication
(10) Pub. No.: US 2016/0294175 A1
(43) Pub. Date: Oct. 6, 2016

(54) Flexture-Type Strain Relief Device

(71) Applicant: NEWPORT CORPORATION, Irvine, CA (US)

(72) Inventors: Hongqi Li, Redwood City, CA (US); Alan Lim, San Jose, CA (US)

(73) Assignee: Newport Corporation, Irvine, CA (US)

(21) Appl. No.: 15/035,463

(22) PCT Filed: Nov. 10, 2014
(86) PCT No.: PCT/US2014/064861

§ 371 Date: May 9, 2016

Related U.S. Application Data
(60) Provisional application No. 61/904,890, filed on Nov. 15, 2013.

(51) Int. Cl. H02G 15/007; F16L 3/22; G02B 6/44

(52) U.S. Cl. CPC H02G 15/007; G02B 6/4471; F16L 3/222

(57) ABSTRACT

The present application is directed to a flexure-type strain relief device and includes a device body having a first surface and at least one support member formed on the device body, at least one fastener receiver may be formed in and traversing through the device body, at least one flex channel formed in and traversing through the device body and configured to be selectively movable in relation to at least one of the first surface of the device body and the support member of the device body, and at least one conduit receiving port formed in the flex channel wherein at least one transverse dimension of the receiving port configured to be selectively adjustable by controllably moving the flex channel thereby applying at least one clamping force to at least one conduit positioned within the receiving port.

### CROSS-REFERENCE TO RELATED APPLICATIONS

The present application claims priority to U.S. Provisional Patent Application Ser. No. 61/904,890, entitled “Flexure-Type Strain Relief Device,” filed on Nov. 15, 2013, the contents of which are incorporated by reference in its entirety herein.

### BACKGROUND

Presently, conduits, wires, fiber optic elements, waveguides, and like are used in an ever growing number of devices and applications. Often, these conduits provide power, control information and the like to one or more processors and/or devices within or positioned on a work surface. Over time, translation, movement, and/or additional stresses may result in the conduit weakening, breaking, separating, or otherwise failing. For example, often this failure occurs at the point of connection between the conduit and a device and/or structure to which the conduit is providing power, information, or other material. As such, the functionality of the system may be compromised.

In light of the foregoing, a number of strain relief approaches have been developed to reduce or eliminate the failure of these conduits, particularly at the coupling point between the conduit and a device and/or structure. For example, one approach which has proven somewhat useful in the past requires at least a portion of the conduit be wound around an immovable feature of the work surface. For example, one or more pins, screws, and the like may be affixed to the work surface. Thereafter, a portion of the conduit is wound around the pin, and the termination end of the conduit is coupled to a device on the work surface. Thereafter, power, control signals, and the like may be provided to the device via the conduit. When a pulling force is applied to the conduit the pulling force is concentrated on the winding region proximate to the pin rather than at the point where the conduit is coupled to the device. While this approach has been somewhat useful in the past, a number of shortcomings have been identified. For example, this approach may be impractical for small and/or size-sensitive applications. In additional, some conduits lack sufficient flexibility to permit this approach.

In light of the foregoing, there is an ongoing need for a strain relief device capable of adjustably and securely coupling one or more conduits of various sizes and dimensions to a device or structure.

### SUMMARY

The present application is directed to a flexure-type strain relief device and includes a device body having a first surface and at least one support member formed on the device body. At least one fastener receiver may be formed in and traversing through the device body. The fastener receiver includes at least one fastener passage formed therein configured to receive at least one fastener therein. Further, the flexure-type strain relief device includes at least one flex channel formed in and traversing through the device body. The flex channel is configured to be selectively movable in relation to at least one of the first surface of the device body and the support member of the device body. In addition, the flexure-type strain relief device includes at least one conduit receiving port formed in the flex channel wherein at least one transverse dimension of the receiving port configured to be selectively adjustable by controllably moving the flex channel thereby applying at least one clamping force to at least one conduit positioned within the receiving port.

In another embodiment, the present application is directed to a flexure-type strain relief device which includes a device body having a first surface and at least one support member formed on the device body. At least one fastener receiver is formed in and traverses through the device body The fastener receiver includes at least one fastener passage configured to receive at least one fastener therein. Further, the flexure-type strain relief device includes at least one flex channel formed in and traversing through the device body wherein the flex channel configured to be selectively movable in relation to at least one of the first surface of the device body and the support member of the device body. As such, at least one transverse dimension of the flex channel is selectively variable. Further, the flexure-type strain relief device includes at least one conduit receiving port formed in the flex channel. At least one transverse dimension of the receiving port configured to be selectively adjustable by controllably moving the flex channel thereby applying at least one clamping force to at least one conduit positioned within the receiving port.

Lastly, the present application is directed to a flexure-type strain relief device and includes a device body having a first surface and at least one support member formed on the device body. At least one fastener receiver is formed in and traverses through the device body, the fastener receiver having at least one fastener passage formed therein. The fastener passage is configured to receive at least one fastener therein. Further, at least two flex channels are formed in and traversing through the device body, the flex channels configured to be selectively movable in relation to at least one of the first surface of the device body and the support member of the device body. Lastly, the flexure-type strain relief device includes at least one conduit receiving port formed in the flex channels. At least one transverse dimension of the receiving port is configured to be selectively adjustable by controllably moving the flex channels thereby applying at least one clamping force to at least one conduit positioned within the receiving port.

Other features and advantages of the embodiments of the flexure-type strain relief device as disclosed herein will become apparent from a consideration of the following detailed description.

### BRIEF DESCRIPTION OF THE DRAWINGS

Various embodiments of a flexure-type strain relief device will be explained in more detail by way of the accompanying drawings, wherein:

FIG. 1 shows an elevated perspective view of an embodiment of a flexure-type strain relief device;

FIG. 2 shows a top planar view of an embodiment of a flexure-type strain relief device having a circular device body;

FIG. 3 shows a top planar view of an embodiment of a flexure-type strain relief device having a rectangular device body;

FIG. 4 shows an elevated perspective view of another embodiment of a flexure-type strain relief device having a fastener positioned within the fastener passage formed in the device body;

FIG. 5 shows a side planar cross-sectional view of an embodiment of a flexure-type strain relief device having a fastener positioned within the fastener passage of the device body;

FIG. 6 shows a side planar cross-sectional view of an embodiment of a flexure-type strain relief device having a fastener positioned within the fastener passage of the device body applying a clamping force to at least one conduit port formed in the flex channels;

FIG. 7 shows a side planar cross-sectional schematic view of an embodiment of a flexure-type strain relief device having a fastener positioned within the fastener passage of the device body;

FIG. 8 shows a side planar cross-sectional schematic view of an embodiment of a flexure-type strain relief device having a fastener positioned within the fastener passage of the device body applying a clamping force to at least one conduit port formed in the flex channels;

FIG. 9 shows a side perspective view of an piezo-actuator having a flexure-type strain relief device attached thereon; and

FIG. 10 shows a more detailed side perspective view of the piezo-actuator having a flexure-type strain relief device attached thereon shown in FIG. 9.

### DETAILED DESCRIPTION

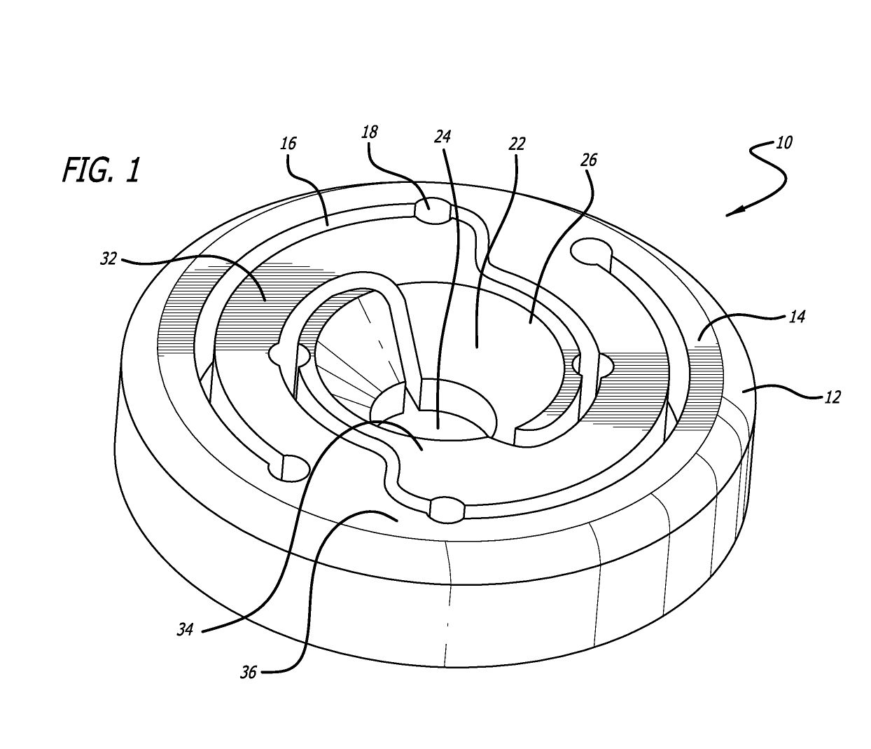

FIGS. 1-4 shows various view of embodiments of the flexure-type strain relief device. As shown, the strain relief device 10 includes at least one relief device body 12 having at least a first surface 14. In the illustrated embodiment, the relief device body 12 comprises a circular shape. Those skilled in the art will appreciate that the device body 12 may be formed in any variety of shapes and configurations. For example, FIG. 3 shows an embodiment of a flexure-type strain relief device 10 having a substantially rectangular device body 12.

Referring again to FIGS. 1-4, in one embodiment the relief device body 12 is manufactured from aluminum. In another embodiment, the relief device body 12 is manufactured from at least one polymer. Optionally, the relief device body 12 may be manufactured from any variety of materials or combination of materials including, without limitations, steel, alloys, plastics, polymers, elastomers, rubber, silicon, composite materials, natural fibers and materials, and the like. As such, the relief device body 12 may be compliant. Optionally, the relief device body 12 may comprise a rigid, non-compliant member. In another embodiment, the relief device body 12 may comprise complaint and non-compliant members or elements.

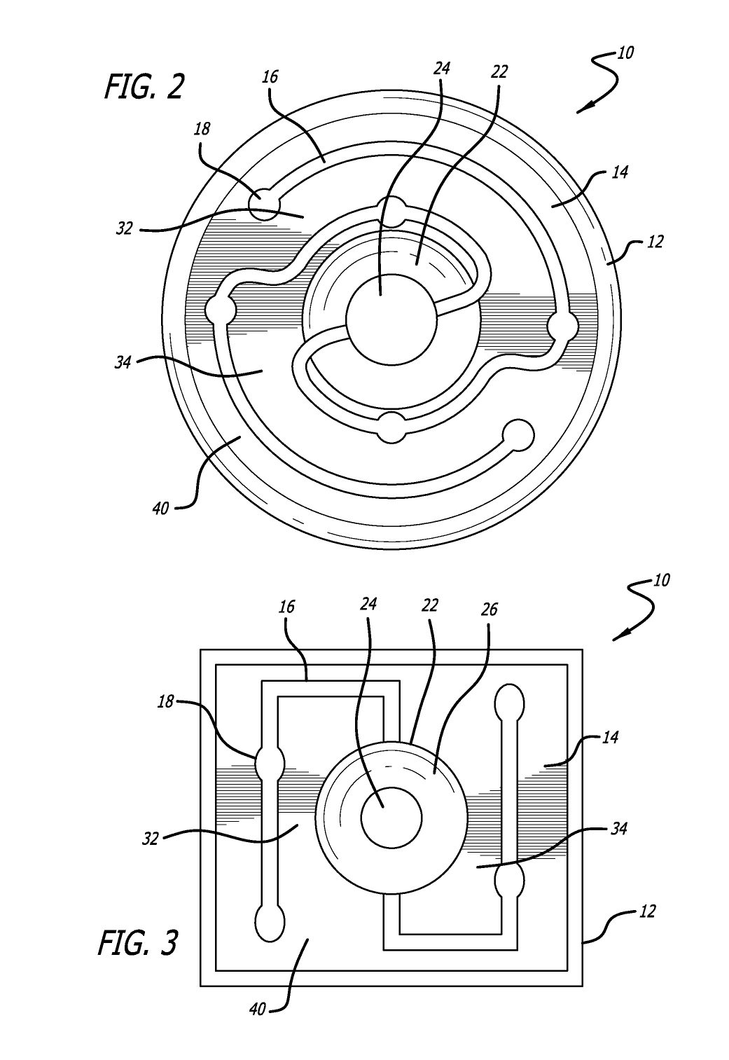

Referring again to FIGS. 1-4, one or more flex channels 16 may be formed in the relief device body 12. FIGS. 1 and 2 show various views of an embodiment of a strain relief device 10 having two (2) flex channels 16 formed in the body of the relief device body 12. In contrast, FIG. 3 shows an embodiment of another embodiment of a strain relief device 10 having four (4) flex channels 16 formed in the body of the relief device body 12. Those skilled in the art will appreciate that the strain relief device 10 may be manufactured with any number of stain relief channels 16 formed in the relief device body 16.

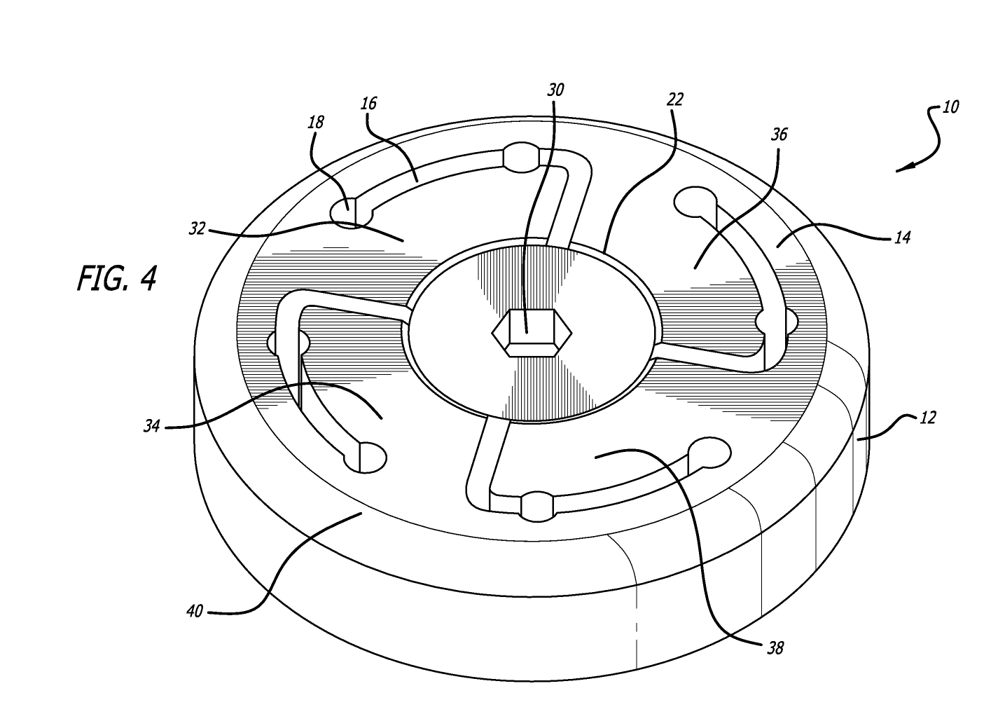

As shown in FIGS. 1-4, the flex channels 16 may traverse the relief device body 12. Further, the flex channels 16 may include one or more conduit or device receiving ports 18 formed therein. For example, the strain relief device 10 shown in FIGS. 1-3 include three (3) conduit receiving ports 18 formed in each flex channel 16. In contrast, the embodiment of the strain relief device 10 shown in FIG. 4 includes two (2) conduit receiving ports 18 formed in each flex channel 16. In short, any number of conduit receiving ports 18 may be formed in any number of flex channels 16. Optionally, the flex channels 16 may be formed without conduit receiving ports 18. Further, in the illustrated embodiment the receiving ports 18 comprise circular receiving ports. Those skilled in the art will appreciate that the receiving ports 18 may be formed in any variety of shapes, sizes, and/or configurations.

Referring again to FIGS. 1-4, the flex channels 16 may define one or more flex members. For example, FIGS. 1-3 show an embodiment of a strain relief device 10 having a first flex member 32 and second flex member 34 formed by the flex channels 16. In contrast, FIG. 4 shows an embodiment of a strain relief device 10 having four (4) flex members32, 34, 36, and 38 formed by the flex channels 16. During use, the flex members 32, 34, 36, and/or 38 may be movable and/or deformable in relation to the support member 40 formed on the first surface 14 of the relief device body 12, thereby permitting a transverse dimension of at least one of the flex channels 16 and conduit receiving ports 18 to be varied to providing a clamping force to at least one conduit of other structure positioned therein.

Referring again to FIGS. 1-3, at least one fastener receiver 22 having at least one fastener passage 24 may be formed therein may be formed in the relief device body 12 of the strain relief device 10. For example, FIGS. 1 and 2 show various views of a strain relief device 10 having a single fastener passage 24 sized to receive at least on fastener (not shown) therein. FIG. 3 shows an embodiment of a strain relief device 10 having a fastener 30 positioned within the fastener receiver 22.

As shown in FIGS. 4-8, in one embodiment at least one angled fastener wall 26 forming at least a portion of the fastener receiver 22 may be angled to receive and engage a portion of a fastener 30 (See FIG. 3) positioned with the fastener receiver 22. In one embodiment, the angled fastener wall 26 is configured to translate the axial clamping force F₁ applied by a fastener device 30 positioned within the fastener receiver 22 to a radial conduit clamping force F₂, thereby varying a transverse dimension of the flexure channel 16, the conduit receiving port 18, or both. As a result, strain relief device 10 may be easily configured to securely retaining at least one conduit, wire, or other device positioned within the flexure channel 16 or conduit receiving area 18 formed on the relief device body 12.

As shown in FIGS. 4 and 6, the prior to installation of the fastener 30 within the fastener passage, the flexure channels 16 and/or the conduit receiving ports 18 have a first transverse dimension W₁ sized to receive at least one conduit, wire, or body 44 therein. In one embodiment, the conduit 44 comprises at least one electrical wire or similar device therein.

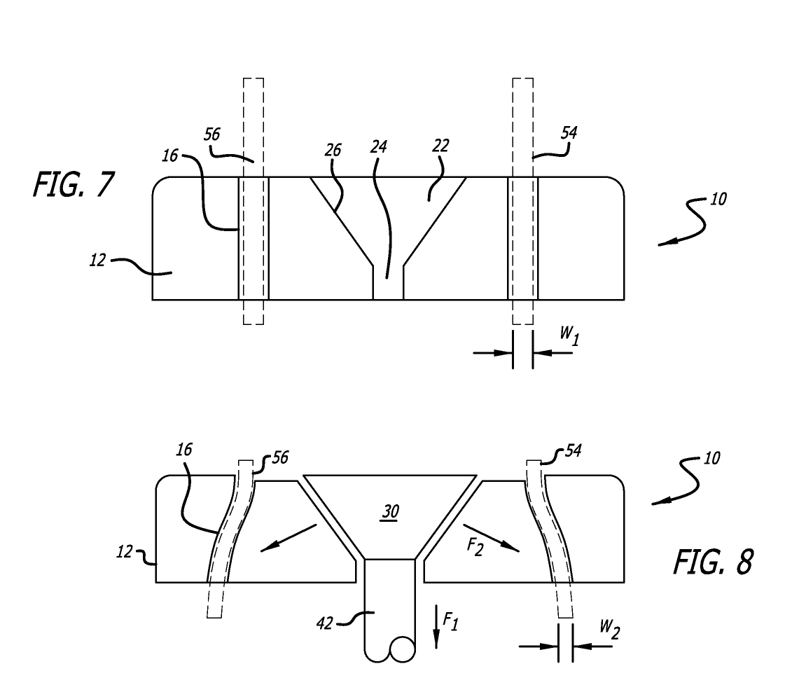

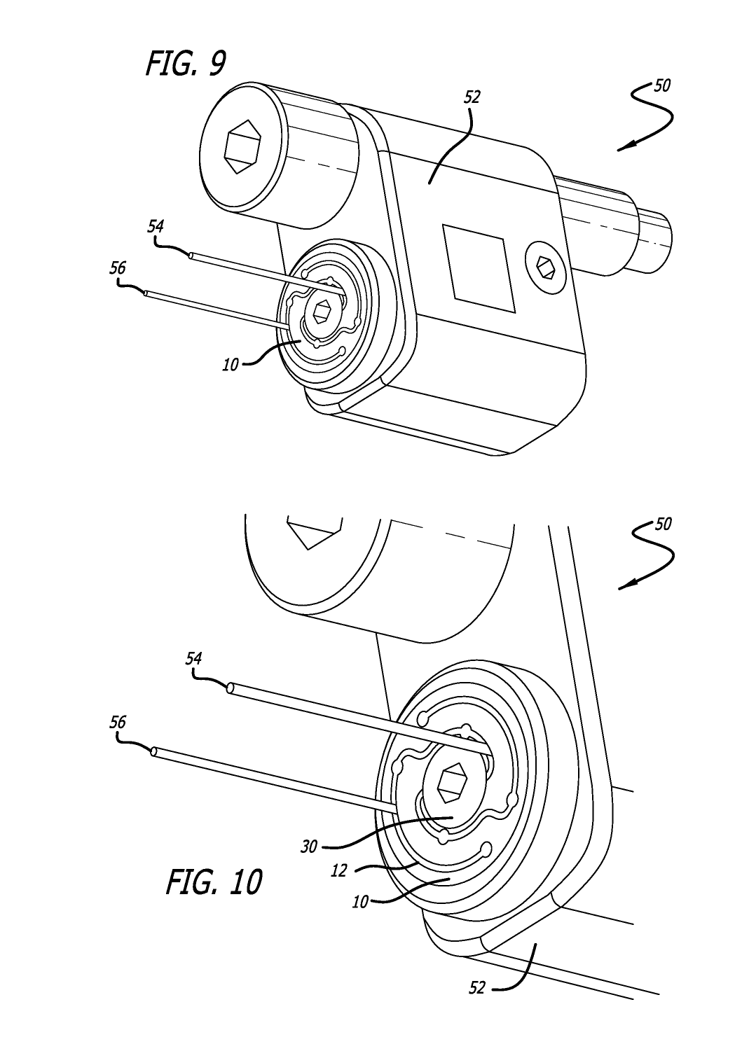

During use, one or more conduits 44 are positioned within at least one of the flexure channels 16 and/or the conduit receiving ports 18 formed on the first surface 14 of the relief device body 12. Those skilled in the art will appreciate that the transverse dimension W1 of at least one of the flexure channel 16 and/or conduit receiving port 18 is sized to permit the easy insertion and removal of conduits 44 from the flexure channel 16 and/or conduit receiving port 18 prior to the installation of the fastener 30. In the illustrated embodiment, a first conduit 54 and second conduit 56 are inserted through the flexure channels 16 and/or conduit receiving ports 18 formed on the strain relief device 10, such that the first and second conduits 54, 56 may be coupled (e.g. electrically, hydraulically, optically, etc.) to at least one motor, processor, and the like located on or within the work surface or device. Thereafter, the strain relief device 10 may be coupled to a work surface or device. For example, FIG. 8 shows an embodiment of a strain relief device 10 detachably coupled to a piezo-actuator 50. As shown, the piezo actuator 50 includes an actuator body 52 sized to receive the strain relief device 10 thereon. For example, the actuator body 52 may include one or more fastener orifices (not shown) sized to receive at least one fastener 30 therein.

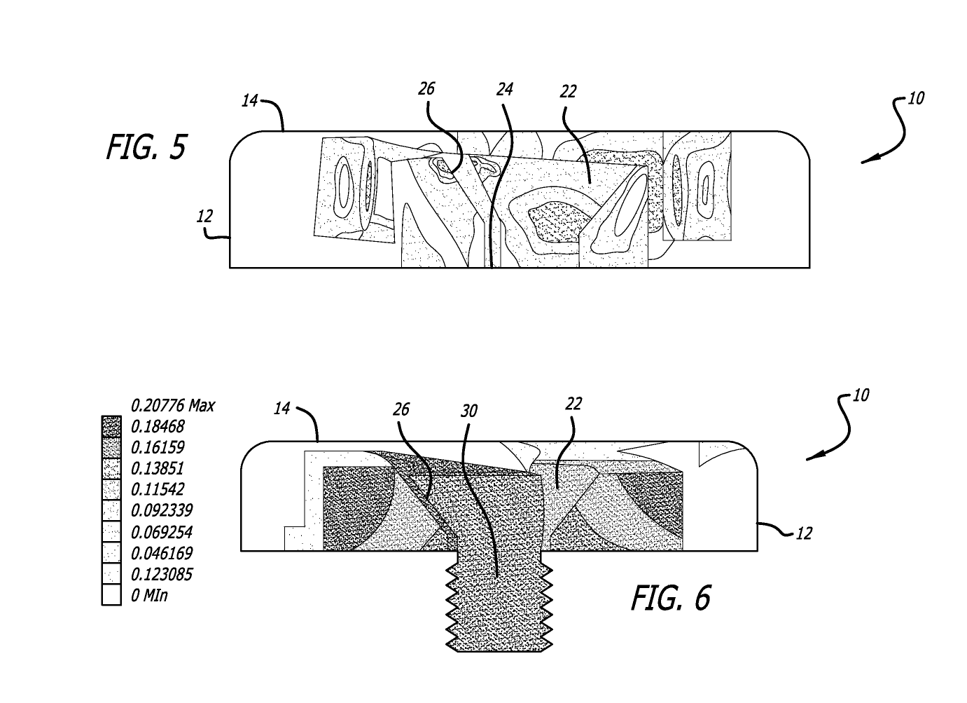

As shown in FIGS. 5, 7, and 8, at least one fastener 30 may be inserted through the fastener passage 24 formed in the fastener receiver 22 and made to engage the fastener orifice (not shown) formed on the actuator body 52. In one embodiment, the fastener 30 comprises one or more threaded members 42 configured to engage the actuator body 52. Thereafter, the user may actuate the fastener 30 to couple the strain relief device 10 to the actuator body 52. In the illustrated embodiment, the fastener is rotated such that the thread members 42 engage the actuator body 52. In addition, the actuation of the fastener 30 within the fastener receiver 22 results in the fastener 30 engaging the angled fastener wall 26 which results in movement of at least one flex member 32, 34, 36, and/or 38 relative to the support member 40, which results in an axial clamping force F₁ being applied by a fastener device 30 positioned within the fastener receiver 22 to be translated to a radial conduit clamping force F₂ applied by the flex members 32, 34, 36, and/or 38 to the conduit. As a result, the transverse dimension of the flexure channel 16 and/or conduit receiving port 18 is varied such that the conduits 54, 56 are securely retained within the flexure channel 16 and/or conduit receiving port 18. As such, in addition to securely coupling the strain relief device 10 to the work surface (e.g. actuator body 52, the fastener 30 inserted through the fastener receiver 22 securely couples conduits 54, 56 to the work surface.

The embodiments disclosed herein are illustrative of the principles of the invention. Other modifications may be employed which are within the scope of the invention. Accordingly, the devices disclosed in the present application are not limited to that precisely as shown and described herein.

1. A flexture-type strain relief device, comprising:
at least one device body having a first surface and at least one support member formed on the device body;
at least one fastener receiver formed in and traversing through the device body, the fastener receiver having at least one fastener passage formed therein, the fastener passage configured to receive at least one fastener therein;
at least one flex channel formed in and traversing through the device body, the flex channel configured to be selectively movable in relation to at least one the first surface and the support member of the device body; and
at least one conduit receiving port formed in the flex channel, at least one transverse dimension of the receiving port configured to be selectively adjustable by controllably moving the flex channel thereby applying at least one clamping force to at least one conduit positioned within the receiving port.

2. The flexture-type strain relief device of claim 1 wherein the device body is manufactured from aluminum.

3. The flexture-type strain relief device of claim 1 wherein the device body is manufactured from at least one material selected from the group consisting of steel, alloys, plastics, polymers, elastomers, rubber, silicon, composite materials, natural fibers and materials.

4. The flexture-type strain relief device of claim 1 wherein the device body comprises a circular shape.

5. The flexture-type strain relief device of claim 1 wherein the device body comprises a rectangular shape.

6. The flexture-type strain relief device of claim 1 wherein the fastener receiver includes at least one angled wall.

7. The flexture-type strain relief device of claim 1 wherein the fastener comprises at least one threaded member.

8. The flexture-type strain relief device of claim 1 wherein the device body includes at least two flex channels.

9. The flexture-type strain relief device of claim 1 wherein the device body includes at least three flex channels.

10. The flexture-type strain relief device of claim 1 wherein at least one transverse dimension of the flex channel is selectively variable.

11. The flexture-type strain relief device of claim 10 wherein the transverse dimension of the flex channel is selectively varied by actuating the fastener positioned within the fastener passage of the fastener recess

12. The flexture-type strain relief device of claim 1 wherein the transverse dimension of the conduit port is configured to be varied by actuating the fastener positioned within the fastener passage of the fastener recess.

13. A flexture-type strain relief device, comprising:
at least one device body having a first surface and at least one support member formed on the device body;
at least one fastener receiver formed in and traversing through the device body, the fastener receiver having at least one fastener passage formed therein, the fastener passage configured to receive at least one fastener therein;
at least one flex channel formed in and traversing through the device body, the flex channel configured to be selectively movable in relation to at least one the first surface and the support member of the device body wherein at least one transverse dimension of the flex channel is selectively variable; and
at least one conduit receiving port formed in the flex channel, at least one transverse dimension of the receiving port configured to be selectively adjustable by controllably moving the flex channel thereby applying at least one clamping force to at least one conduit positioned within the receiving port.

14. The flexture-type strain relief device of claim 13 wherein the device body is manufactured from aluminum.

15. The flexture-type strain relief device of claim 13 wherein the device body is manufactured from at least one material selected from the group consisting of steel, alloys, plastics, polymers, elastomers, rubber, silicon, composite materials, natural fibers and materials.

16. The flexture-type strain relief device of claim 13 wherein the device body comprises a circular shape.

17. The flexture-type strain relief device of claim 13 wherein the device body comprises a rectangular shape.

18. The flexture-type strain relief device of claim 13 wherein wherein the fastener receiver includes at least one angled wall.

19. The flexture-type strain relief device of claim 13 wherein the fastener comprises at least one threaded member.

20. The flexture-type strain relief device of claim 13 wherein the device body includes at least two flex channels.

21. The flexture-type strain relief device of claim 13 wherein the device body includes at least three flex channels.

22. The flexture-type strain relief device of claim 13 wherein the transverse dimension of the flex channel is configured to be varied by actuating the fastener positioned within the fastener passage of the fastener recess

23. The flexture-type strain relief device of claim 13 wherein the transverse dimension of the conduit port is configured to be varied by actuating the fastener positioned within the fastener passage of the fastener recess.

24. A flexture-type strain relief device, comprising:
at least one device body having a first surface and at least one support member formed on the device body;
at least one fastener receiver formed in and traversing through the device body, the fastener receiver having at least one fastener passage formed therein, the fastener passage configured to receive at least one fastener therein;
at least two flex channels formed in and traversing through the device body, the flex channels configured to be selectively movable in relation to at least one the first surface and the support member of the device body; and
at least one conduit receiving port formed in the flex channel, at least one transverse dimension of the receiving port configured to be selectively adjustable by controllably moving the flex channel thereby applying at least one clamping force to at least one conduit positioned within the receiving port.

25. The flexture-type strain relief device of claim 24 wherein at least one transverse dimension of at least one flex channels is selectively variable.

26. The flexture-type strain relief device of claim 25 wherein the transverse dimension of the flex channels are configured to be varied by actuating the fastener positioned within the fastener passage of the fastener recess.

27. The flexture-type strain relief device of claim 24 wherein the transverse dimension of the conduit receiving ports are configured to be varied by actuating the fastener positioned within the fastener passage of the fastener recess.
